(19) United States
(12) Patent Application Publication
(10) Pub. No.: US 2020/0127352 A1
(43) Pub. Date: Apr. 23, 2020

(54) BATTERY COOLING SYSTEM

(71) Applicant: TOYOTA JIDOSHA KABUSHIKI KAISHA, Toyota-shi (JP)

(72) Inventor: Daisuke TOKOZAKURA, Susono-shi (JP)

(73) Assignee: TOYOTA JIDOSHA KABUSHIKI KAISHA, Toyota-shi (JP)

(21) Appl. No.: 16/596,906

(22) Filed: Oct. 9, 2019

(30) Foreign Application Priority Data
Oct. 17, 2018 (JP) 2018-196153

(51) Int. Cl. H01M 10/66; H01M 10/613; H01M 10/625; H01M 10/633; H01M 10/6552; H01M 10/6568; F16N 13/22; F16N 17/02; B60L 58/26; F16N 7/40; F16N 29/00; F16H 57/04

(52) U.S. Cl. CPC H01M 10/66; H01M 10/613; H01M 10/625; H01M 10/633; H01M 10/6552; H01M 10/6568; F16N 2039/007; F16N 17/02; B60L 58/26; F16N 7/40; F16N 29/00; F16H 57/0476; H01M 2220/20; F16N 13/22

(57) ABSTRACT

A battery cooling system includes: a circulation circuit configured to circulate common oil to a transaxle, a battery, and an oil cooler; a first electric oil pump that is disposed in a first oil passage; a second electric oil pump that is disposed in a second oil passage; and a controller configured to control the first electric oil pump and the second electric oil pump. The controller is configured to operate the first electric oil pump and stop the second electric oil pump when a temperature of the battery is equal to or lower than a first predetermined value, and stop the first electric oil pump and operate the second electric oil pump when the temperature of the battery is higher than the first predetermined value.

### CROSS-REFERENCE TO RELATED APPLICATION(S)

The present application claims priority to and incorporates by reference the entire contents of Japanese Patent Application No. 2018-196153 filed in Japan on Oct. 17, 2018.

### BACKGROUND

### 1. Technical Field

The present disclosure relates to a battery cooling system.

### 2. Related Art

Japanese Patent No. 6269889 discloses a battery cooling system loaded into a vehicle, in which oil for lubrication of a transaxle is used to cool a battery unit.

Meanwhile, voltages of battery cells that constitute a battery unit decrease with temperature decrease, and it is therefore necessary to warm up the battery cells in some cases. However, a configuration described in Japanese Patent No. 6269889 is a circuit configuration in which a transaxle, an oil cooler, and a battery unit are connected in a closed loop; therefore, the circuit is dedicated to cooling and does not take into account warm-up of battery cells. It is therefore possible to consider to apply a circuit configuration that can cool and warm up the battery cells. However, in this case, control according to the temperature of the battery cells is required; therefore, disposing, for example, a changeover valve (an electromagnetic valve) or a circuit that is required for switching of the changeover valve may result in a complicated system configuration.

### SUMMARY

The disclosure has been made in view of circumstances described above, and it is desirable that a battery cooling system can cool and warm up a battery with a simple system configuration.

In some embodiments, a battery cooling system includes: a circulation circuit configured to circulate common oil to a transaxle, a battery, and an oil cooler, the oil for lubrication of the transaxle being used to cool the battery; a first electric oil pump that is disposed in a first oil passage configured to supply the oil to the transaxle and the battery, not through the oil cooler, in the circulation circuit; a second electric oil pump that is disposed in a second oil passage configured to supply the oil to the transaxle and the battery through the oil cooler, in the circulation circuit; and a controller configured to control the first electric oil pump and the second electric oil pump. The controller is configured to operate the first electric oil pump and stop the second electric oil pump when a temperature of the battery is equal to or lower than a first predetermined value, and stop the first electric oil pump and operate the second electric oil pump when the temperature of the battery is higher than the first predetermined value.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a configuration diagram schematically illustrating a battery cooling system according to a first embodiment;

FIG. 2 is a diagram schematically illustrating a circulation circuit in a transaxle case;

FIG. 3 is a diagram illustrating a battery cell being directly cooled with oil;

FIG. 4 is a flowchart illustrating a control flow for operation of electric oil pumps;

FIG. 5 is a diagram illustrating a relationship between a change in temperature of battery cells and a change in voltage;

FIG. 6 is a diagram for describing a flow of the oil for warm-up of a battery;

FIG. 7 is a diagram for describing a flow of the oil for cooling of the battery;

FIG. 8 is a flowchart illustrating a control flow for operation of electric oil pumps according to a second embodiment;

FIG. 9 is a diagram for describing a relationship between the temperature of battery cells and the temperature of a motor; and

FIG. 10 is a diagram for describing a flow of oil for temperature retention of a battery.

### DETAILED DESCRIPTION

Hereinafter, with reference to the drawings, a battery cooling system according to embodiments of the disclosure will be described in detail.

### First Embodiment

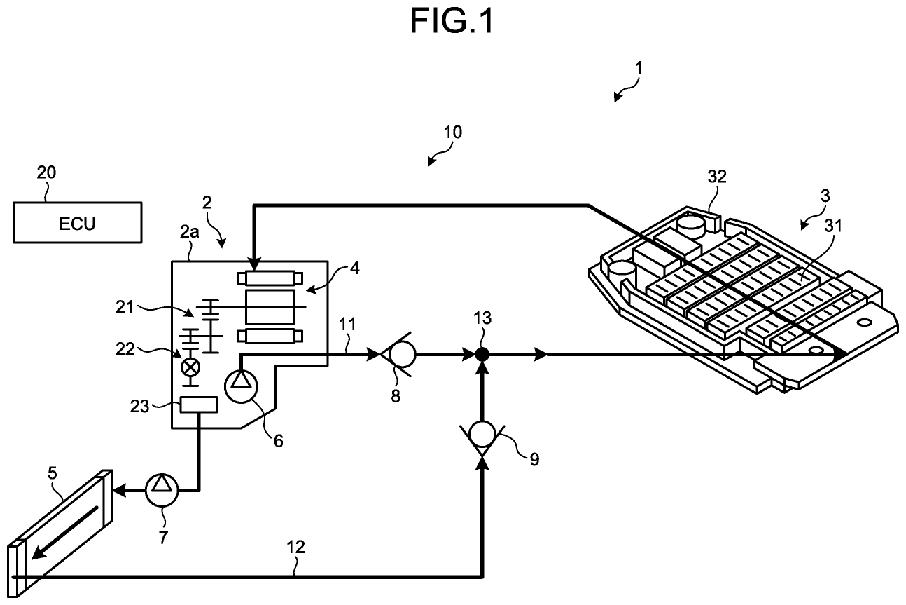

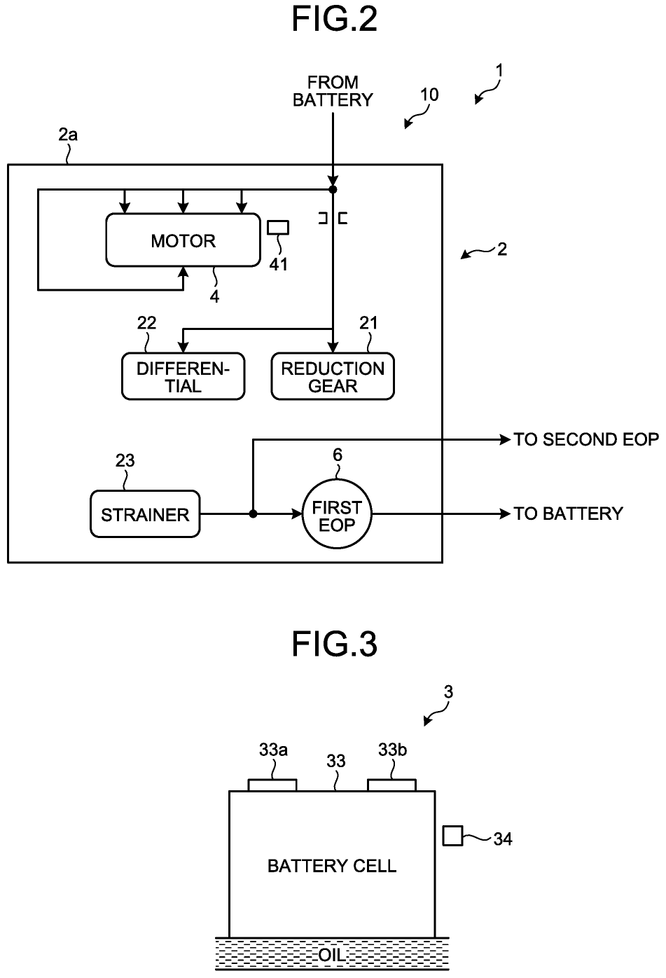

FIG. 1 is a configuration diagram schematically illustrating a battery cooling system according to a first embodiment. FIG. 2 is a diagram schematically illustrating a circulation circuit in a transaxle case. Note that, in FIG. 1, a thick line indicates a situation in which oil is flowing in an oil passage, with no distinction between cooling and warm-up of a battery.

A battery cooling system 1 according to the first embodiment is a cooling system loaded into an electric car, and is configured to use oil for lubrication of a transaxle 2 to cool and warm up a battery 3. As illustrated in FIG. 1, the battery cooling system 1 includes a circulation circuit 10 in which the oil circulates between the transaxle 2 and the battery 3, and an ECU 20 that controls switching between cooling and warm-up of the battery 3 according to the temperature of the battery 3. The battery cooling system 1 is a system that can switch cooling and warm-up of the battery 3 without using a changeover valve or the like.

The transaxle 2 includes a power transmission mechanism such as a transmission housed in a transaxle case 2a, and includes a reduction gear 21 and a differential mechanism (differential) 22. The reduction gear 21 and the differential mechanism 22 are portions to be lubricated that require lubrication with the oil. The reduction gear 21 includes a gear pair. The oil that circulates through the circulation circuit 10 is temporarily stored in the transaxle case 2a.

A motor 4 that serves as a power source is housed inside the transaxle case 2a. The motor 4 is a motor generator and has a power generation function. The motor 4 is a portion to be cooled that requires cooling with the oil. Then, the motor 4 is driven by using electricity accumulated in the battery 3. Power output from the motor 4 is input to the transaxle 2, and is transmitted from the transaxle 2 to a wheel (not illustrated). The motor 4 is driven and controlled by the ECU 20. The electric car is loaded with a transaxle unit in which the portions to be lubricated such as the reduction gear 21 that constitute the power transmission mechanism and the motor 4 that is the portion to be cooled are housed in the transaxle case 2a.

The battery 3 includes a secondary battery in which electricity to be supplied to the motor 4 for running is accumulated. The battery 3 includes a plurality of battery modules 31 each including a plurality of battery cells 33 (illustrated in FIG. 3), and includes a battery pack in which the plurality of battery modules 31 is housed in a battery case 32. The oil supplied to the battery 3 flows through each battery module 31, contacting surfaces of the battery cells 33. Note that the oil flows through portions where the oil does not contact electrodes 33a and 33b of the battery cells 33.

The circulation circuit 10 is an oil circuit that circulates common oil to the transaxle 2, the battery 3, and an oil cooler 5. The circulation circuit 10 includes a first electric oil pump (first EOP) 6, a second electric oil pump (second EOP) 7, the oil cooler 5, the battery 3, the motor 4, the reduction gear 21, and the differential mechanism 22.

As illustrated in FIG. 1, in the circulation circuit 10, a first oil passage 11 that is an oil passage that does not pass through the oil cooler 5 and a second oil passage 12 that is an oil passage that passes through the oil cooler 5 are formed in parallel. The first electric oil pump 6 is disposed in the first oil passage 11. The second electric oil pump 7 is disposed in the second oil passage 12. Then, the first oil passage 11 and the second oil passage 12 converge at a junction 13. By operating the first electric oil pump 6, the oil is supplied to the battery 3 without passing through the oil cooler 5. By operating the second electric oil pump 7 in the second oil passage 12, the oil is supplied to the battery 3 through the oil cooler 5.

The first electric oil pump 6 serves as an oil pump for warm-up, and is disposed inside the transaxle case 2a. By the first electric oil pump 6, the oil stored in the transaxle case 2a is sucked via a strainer 23 and discharged to the first oil passage 11. The first electric oil pump 6 is driven and controlled by the ECU 20. The ECU 20 can control an amount of the oil discharged from the first electric oil pump 6.

The second electric oil pump 7 serves as an oil pump for cooling, and is disposed outside the transaxle case 2a. By the second electric oil pump 7, the oil stored in the transaxle case 2a is sucked via the strainer 23 and discharged to the second oil passage 12. The second electric oil pump 7 is driven and controlled by the ECU 20. The ECU 20 can control an amount of the oil discharged from the second electric oil pump 7. For example, the second electric oil pump 7 is an external oil pump attached externally to the transaxle case 2a, and is configured to be smaller than the first electric oil pump 6. The first electric oil pump 6 in this case is an internal oil pump disposed in the transaxle case 2a.

The first electric oil pump 6, a first check valve 8, the junction 13, the battery 3, and the transaxle 2 are disposed in the first oil passage 11. The junction 13 is disposed between an inflow opening of the battery 3 and the first electric oil pump 6. The first check valve 8 is disposed between the first electric oil pump 6 and the battery 3, and is nearer to the first electric oil pump 6 than the junction 13. When the second electric oil pump 7 operates with the first electric oil pump 6 stopped, the first check valve 8 closes so that the oil on a battery 3 side may not flow back toward a discharge opening of the first electric oil pump 6. On the other hand, the oil discharged by the first electric oil pump 6 is pressure-fed to the battery 3 side via the first check valve 8.

The second electric oil pump 7, the oil cooler 5, a second check valve 9, the junction 13, the battery 3, and the transaxle 2 are disposed in the second oil passage 12. The oil cooler 5 is a radiator that air-cools the oil discharged from the second electric oil pump 7, and radiates heat of the oil to external air. The second check valve 9 is disposed between the oil cooler 5 and the battery 3, and is nearer to the oil cooler 5 than the junction 13. When the first electric oil pump 6 operates with the second electric oil pump 7 stopped, the second check valve 9 closes so that the oil on the battery 3 side may not flow back toward an outlet of the oil cooler 5. On the other hand, the oil discharged by the second electric oil pump 7 passes through the oil cooler 5 and is pressure-fed to the battery 3 side via the second check valve 9.

The oil that has flown into the battery 3 cools the plurality of battery modules 31 housed in the battery case 32 and then flows out to an outside of the battery case 32. In this case, as illustrated in FIG. 3, the oil directly cools the surfaces of the battery cells 33 that constitute the battery modules 31. During warm-up, the oil directly warms up the surfaces of the battery cells 33. That is, the oil flows in contact with the surfaces of the battery cells 33. Moreover, a temperature sensor 34 that detects the temperature of the battery cells 33 is disposed in the battery 3. The temperature sensor 34 is disposed on a battery module 31 arranged on an oil outlet side (downstream side), among the plurality of battery modules 31. This allows for monitoring of the temperature of the battery cells 33, targeting battery cells 33 in which the temperature tends to become relatively high due to being on the downstream side. This temperature sensor 34 outputs a sensor value (signal) the ECU 20. Note that, in the description, the temperature of the battery 3 and the temperature of the battery cells 33 are synonymous.

The oil that has flown out of the battery 3 returns to the transaxle case 2a, and, inside the transaxle case 2a, cools the motor 4. For example, the oil that has returned to the transaxle case 2a is supplied to a stator of the motor 4 as a cooling liquid. The oil that has cooled the motor 4 is temporarily stored in a lower portion (oil reservoir) of the transaxle case 2a. Moreover, the oil that has returned to the transaxle case 2a is supplied as lubricant to, apart from the motor 4, the reduction gear 21 and the differential mechanism 22. The oil that has lubricated the gear and so on is temporarily stored in the lower portion (oil reservoir) of the transaxle case 2a. The oil stored in the oil reservoir is sucked through the strainer 23 by the first electric oil pump 6 or the second electric oil pump 7. Thus, the oil is circulated from the first electric oil pump 6 or the second electric oil pump 7 to the outside of the transaxle case 2a. Since the circulation circuit 10 continues to supply the lubricant to the portions to be lubricated such as the reduction gear 21 and the differential mechanism 22 while the electric car is running, at least either the first electric oil pump 6 or the second electric oil pump 7 is required to keep operating.

Moreover, the oil is a liquid having high insulation properties, low corrosiveness and metal reactivity, low viscosity, and lubricity. For example, a low-viscosity insulating oil (such as mineral oil or synthetic oil) for which an additive for giving a lubricative property has been prescribed is used in the circulation circuit 10 as the oil for cooling the battery. In more detail, as for electrical properties, the oil has a volume resistivity value similar to that of air, and has a volume resistivity value higher than that of LLC (cooling water) or ethylene glycol. Furthermore, the oil has a property of having a high breakdown voltage. As for corrosiveness, the oil has a property of not corroding a copper plate or an aluminum plate. Moreover, the oil has a low water absorption rate. As for reactivity, the oil has a property of not reacting with lithium or electrolytes. Furthermore, the oil does not react with metal (for example, iron, aluminum, and copper).

The ECU 20 is an electronic control unit that controls the electric car on the basis of signals input from various sensors loaded into the electric car, and controls switching between warm-up and cooling of the battery 3 (switching control). The switching control switches operation of the first electric oil pump 6 and operation of the second electric oil pump 7 on the basis of the temperature of the battery cells 33 detected by the temperature sensor 34. In this case, a command signal is output from the ECU 20 to each of the electric oil pumps 6 and 7. Moreover, the ECU 20 can control the first electric oil pump 6 to change the amount of the oil discharged (volume of flow) from the first electric oil pump 6. Likewise, the ECU 20 can control the second electric oil pump 7 to change the amount of the oil discharged (volume of flow) from the second electric oil pump 7.

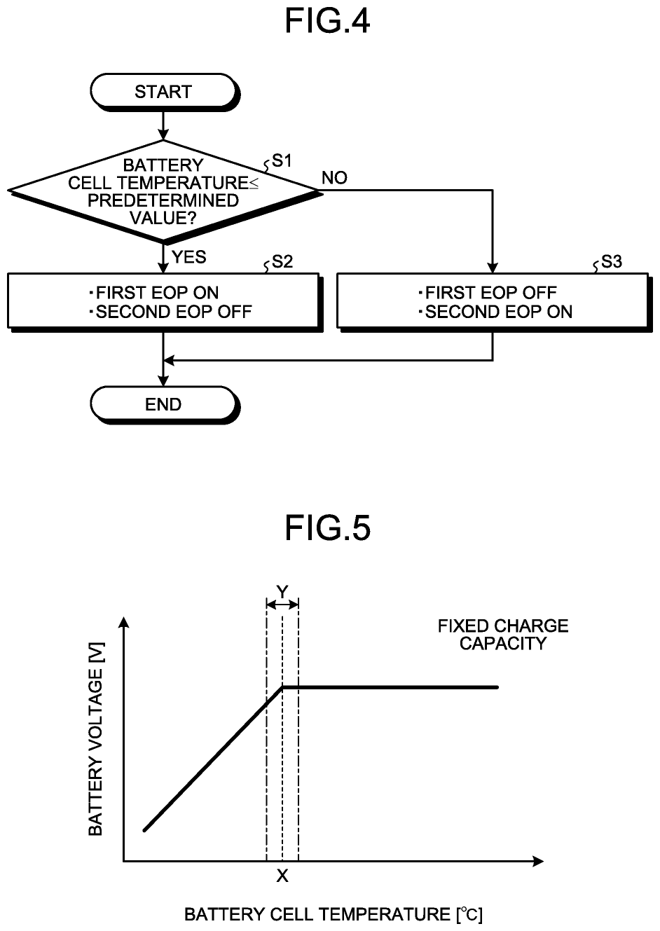

FIG. 4 is a flowchart illustrating a control flow for operation of the electric oil pumps. The control flow illustrated in FIG. 4 is performed by the ECU 20.

The ECU 20 determines whether the temperature of the battery cells 33 is equal to or lower than a predetermined value (Step S1). The predetermined value is set to a temperature in which a voltage of the battery 3 decreases distinctly when a discharge capacity is at a certain value. As an example, in a case where the battery cells 33 are liquid-based lithium-ion batteries, the predetermined value in Step S1 can be set to approximately 5° C. The temperature set as the predetermined value in Step S1 will be described with reference to FIG. 5.

As illustrated in FIG. 5, in a situation where the discharge capacity of the battery 3 is fixed, when the temperature of the battery cells 33 is higher than a predetermined temperature X° C., the voltage of the battery 3 is kept at a fixed value. On the other hand, when the temperature of the battery cells 33 decreases to be equal to or lower than the predetermined temperature X° C., the voltage of the battery 3 begins to decrease. The voltage of the battery 3 decreases distinctly as soon as the temperature of the battery cells 33 reaches the predetermined temperature X° C. In a case where the temperature of the battery cells 33 is equal to or lower than the predetermined temperature X° C., the voltage of the battery cells 33 decreases further as the temperature of the battery cells 33 decreases. In this way, magnitude of the voltage of the battery cells 33 changes distinctly before and after the predetermined temperature X° C. It is therefore possible to set the predetermined temperature X° C. as the predetermined value in Step S1.

Returning to FIG. 4, in a case where the temperature of the battery cells 33 is equal to or lower than the predetermined value (Step S1: Yes), the ECU 20 operates the first electric oil pump 6 and stops the second electric oil pump 7 (Step S2). In Step S2, only the first electric oil pump 6 is operated so that the battery 3 may be warmed up by exhaust heat of the transaxle 2. In this case, only the oil that has not passed through the oil cooler 5 is supplied to the battery 3. When Step S2 is performed, the control routine is terminated.

In a case where the temperature of the battery cells 33 is higher than the predetermined value (Step S1: No), the ECU 20 stops the first electric oil pump 6 and operates the second electric oil pump 7 (Step S3). In Step S3, only the second electric oil pump 7 is operated so that the battery 3 may be cooled by the oil after heat radiation in the oil cooler 5. In this case, only the oil that has passed through the oil cooler 5 is supplied to the battery 3. When Step S3 is performed, the control routine is terminated.

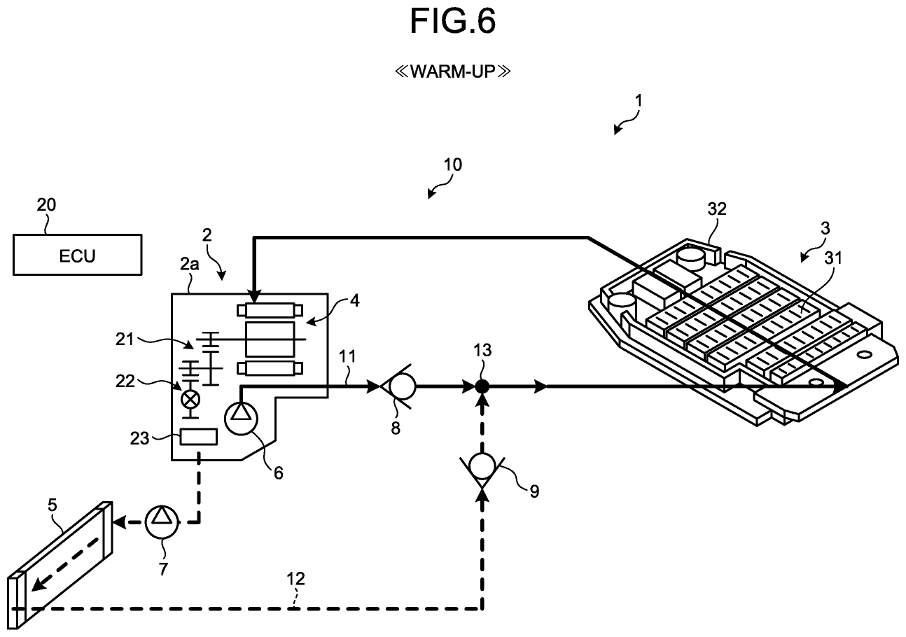

FIG. 6 is a diagram illustrating a flow of the oil for warm-up of the battery 3. Note that in FIG. 6, a thick line indicates a situation in which the oil is flowing in an oil passage, and a dashed line indicates a situation in which the oil is not flowing in an oil passage. Moreover, the situation illustrated in FIG. 6 represents a case where Step S2 described above is performed.

As illustrated in FIG. 6, for warm-up of the battery 3, only the first electric oil pump 6 out of the two electric oil pumps 6 and 7 operates; therefore, the oil flows through a route including the first oil passage 11 in the circulation circuit 10. That is, the oil circulates through the route that does not pass through the oil cooler 5. Moreover, the second check valve 9 is closed because the second electric oil pump 7 is stopped. Consequently, the oil having a temperature that has increased due to the exhaust heat of the transaxle 2 is supplied to the battery 3 without passing through the oil cooler 5. Therefore, the battery 3 can be warmed up by heat of the oil.

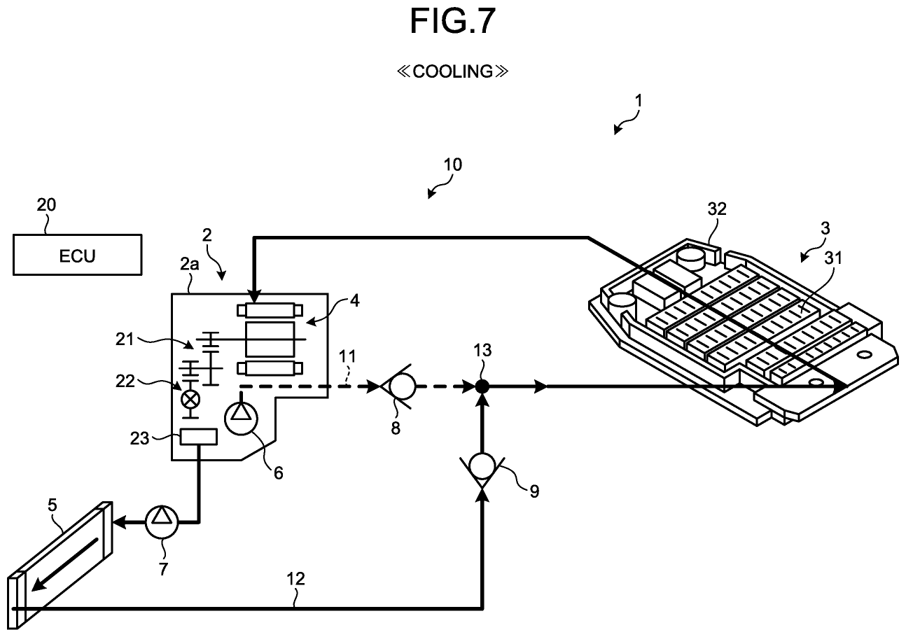

FIG. 7 is a diagram illustrating a flow of the oil for cooling of the battery 3. Note that in FIG. 7, as with FIG. 6, a thick line indicates a situation in which the oil is flowing in an oil passage, and a dashed line indicates a situation in which the oil is not flowing in an oil passage. Moreover, the situation illustrated in FIG. 6 represents a case where Step S3 described above is performed.

As illustrated in FIG. 7, for cooling of the battery 3, only the second electric oil pump 7 out of the two electric oil pumps 6 and 7 operates; therefore, the oil flows through a route including the second oil passage 12 in the circulation circuit 10. That is, the oil circulates through the route that passes through the oil cooler 5. Moreover, the first check valve 8 is closed because the first electric oil pump 6 is stopped. Consequently, only the oil that has been cooled by the oil cooler 5 is supplied to the battery 3. Therefore, the battery 3 can be efficiently cooled.

As described above, according to the first embodiment, warm-up and cooling of the battery 3 can be switched by controlling operation and stop of the first electric oil pump 6 and the second electric oil pump 7 according to the temperature of the battery cells 33. That is, a circuit for warm-up and a circuit for cooling of the battery 3 can be switched by switching operation of the two electric oil pumps 6 and 7. Consequently, switching between cooling and warm-up of the battery 3 can be performed without disposing a changeover valve, a circuit that is required for switching of the changeover valve, or the like. This allows for achievement of the circulation circuit 10 having a simple circuit configuration. Therefore, a simple cooling and warm-up system can be achieved, and weight and cost can be reduced as compared with conventional system configurations. Cooling of the battery 3 is required for prevention of heat deterioration. Warm-up of the battery 3 is required for prevention of a decrease in voltage.

Moreover, by operating only the first electric oil pump 6, the oil can be supplied to the battery 3 without passing through the oil cooler 5; therefore, the battery 3 can be warmed up by the oil warmed by the exhaust heat of the transaxle 2. This eliminates a necessity for installation of a heater or the like and allows for reduction in energy for operating the heater or the like; therefore, loss can be reduced more as compared with conventional system configurations.

Note that in the first embodiment described above, a temperature range Y can be set as the predetermined value in Step S1, not limited to a case where the predetermined temperature X° C. is set. The temperature range Y is, as illustrated in FIG. 5, a temperature range including the predetermined temperature X° C., and can be, for example, a range from some degrees above the predetermined temperature X° C. (upper limit temperature) to some degrees below the predetermined temperature X° C. (lower limit temperature). In this case, in Step S1, whether the temperature of the battery cells 33 is equal to or lower than the temperature range Y is determined. That is, whether the temperature of the battery cells 33 is equal to or lower than the upper limit temperature of the temperature range Y is determined. Since an upper limit of the temperature range Y is higher than the predetermined temperature X, warm-up of the battery cells 33 can be started when the temperature of the battery cells 33 becomes equal to or lower than the upper limit of the temperature range Y. This allows warm-up of the battery cells 33 to be started before the voltage begins to decrease due to a decrease in temperature below the predetermined temperature X. Therefore, a decrease in voltage of the battery 3 can be suppressed.

Moreover, in the battery cooling system 1, both the first electric oil pump 6 and the second electric oil pump 7 can be disposed inside the transaxle case 2a. Alternatively, both the first electric oil pump 6 and the second electric oil pump 7 can be disposed outside the transaxle case 2a.

Furthermore, a vehicle to be loaded with the battery cooling system 1 is not limited to an electric car and can be a hybrid car.

### Second Embodiment

A battery cooling system 1 according to a second embodiment is configured to switch operation of a first electric oil pump 6 and operation of a second electric oil pump 7 on the basis of the temperature of battery cells 33 and the temperature of a motor 4. Note that in description of the second embodiment, as for a configuration similar to that of the first embodiment described above, description will be omitted and the same reference number will be used.

An ECU 20 according to the second embodiment is configured to receive a signal input from a temperature sensor 41 that detects the temperature of the motor 4. The temperature sensor 41 is, for example, a temperature sensor disposed on a coil end of the motor 4. The coil end is a portion of a coil wound around a stator, the portion protruding outward in an axial direction of the stator.

Moreover, the ECU 20 is configured to control temperature retention of a battery 3. Temperature retention of the battery 3 is performed by operating both the first electric oil pump 6 and the second electric oil pump 7. Then, the ECU 20 is configured to control switching among warm-up, temperature retention, and cooling of the battery 3 on the basis of the temperature of the battery cells 33 and the temperature of the motor 4.

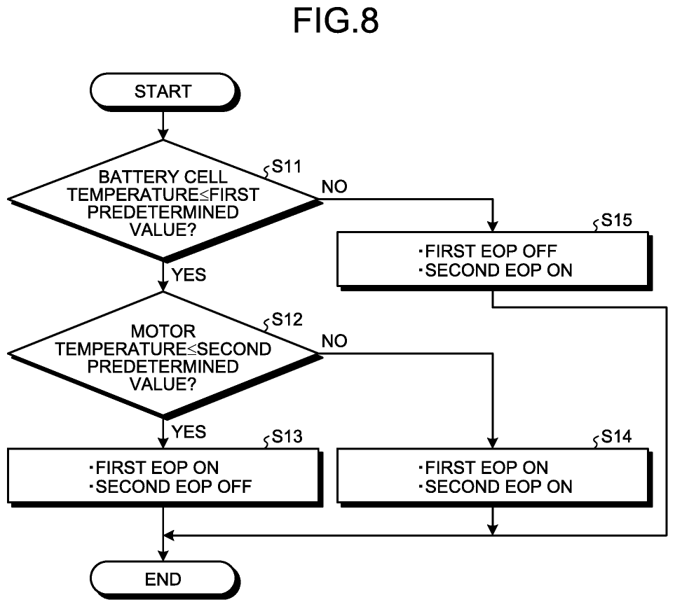

FIG. 8 is a flowchart illustrating a control flow for operation of the electric oil pumps. The control flow illustrated in FIG. 8 is performed by the ECU 20.

The ECU 20 determines whether the temperature of the battery cells 33 is equal to or lower than a first predetermined value (Step S11). In Step S11, processing similar to that of Step S1 in FIG. 4 described above is performed. Therefore, the first predetermined value in Step S11 is synonymous with the predetermined value in Step S1 described above. Moreover, a predetermined value to be compared with the temperature of the battery cells 33 in Step S11 can be expressed as the first predetermined value.

In a case where the temperature of the battery cells 33 is equal to or lower than the first predetermined value (Step S11: Yes), the ECU 20 determines whether the temperature of the motor 4 is equal to or lower than a second predetermined value (Step S12). The second predetermined value in Step S12 is a predetermined value to be compared with the temperature of the motor 4. The second predetermined value can be set to a value different from the first predetermined value in Step S11 described above. The second predetermined value in Step S12 can be set to a predetermined temperature in which it is desirable to prioritize cooling of the motor 4 between cooling of the motor 4 and cooling of the battery 3, for example, the temperature equal to or higher than the first predetermined value.

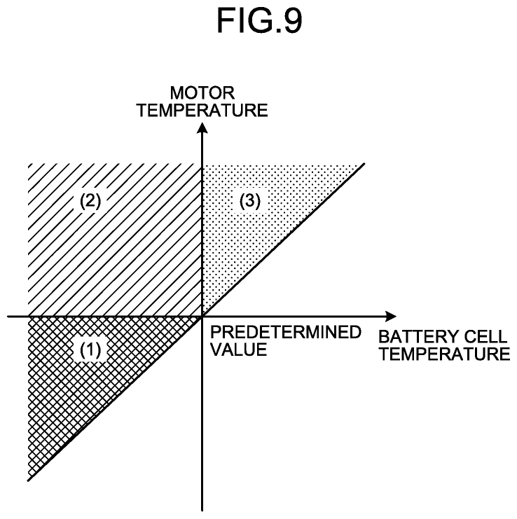

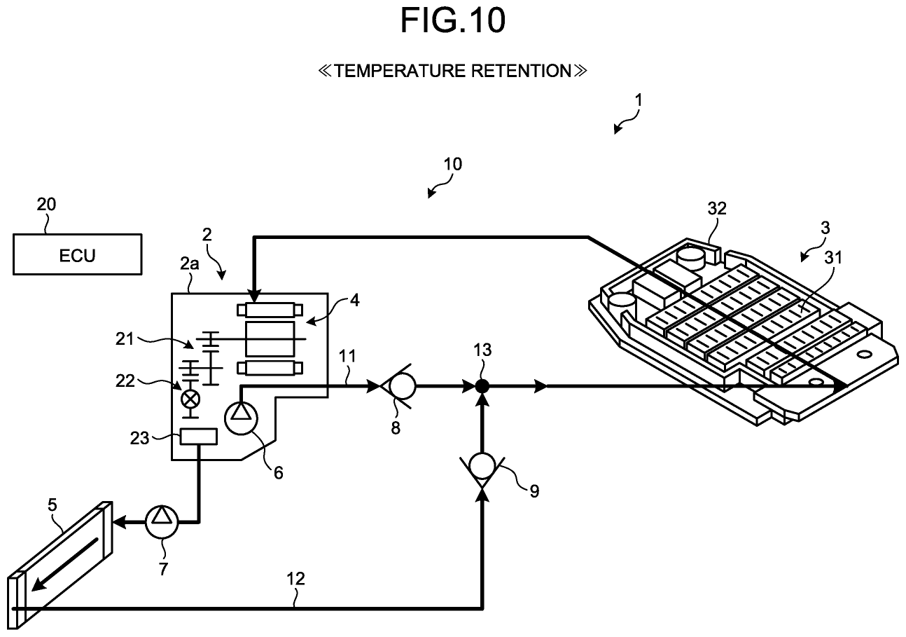

In a case where the temperature of the motor 4 is equal to or lower than the second predetermined value (Step S12: Yes), the ECU 20 operates the first electric oil pump 6 and stops the second electric oil pump 7 (Step S13). A case where a positive determination is made in Step S12, which is a condition for performing Step S13, is a case where the temperature of the battery cells 33 is equal to or lower than the first predetermined value and the temperature of the motor 4 is equal to or lower than the second predetermined value. In this case, in a case of, for example, a first temperature situation (1) illustrated in FIG. 9, Step S13 is performed to warm up the battery 3. When Step S13 is performed, the control routine is terminated. Note that a predetermined value related to the temperature of the battery cells 33 as a horizontal axis in FIG. 9 (equivalent to the first predetermined value) and a predetermined value related to the temperature of the motor 4 as a vertical axis in FIG. 9 (equivalent to the second predetermined value) can be different values.

In a case where the temperature of the motor 4 is higher than the second predetermined value (Step S12: No), the ECU 20 operates the first electric oil pump 6 and operates the second electric oil pump 7 (Step S14). In Step S14, both the first electric oil pump 6 and the second electric oil pump 7 are operated to converge oil warmed by exhaust heat of a transaxle 2 and oil after heat radiation in an oil cooler 5 and supply the converged oil to the battery 3 for temperature retention of the battery 3.

A case where a negative determination is made in Step S12, which is a condition for performing Step S14, is a case where the temperature of the battery cells 33 is equal to or lower than the first predetermined value and the temperature of the motor 4 is higher than the second predetermined value. In this case, in a case of, for example, a second temperature situation (2) illustrated in FIG. 9, Step S14 is performed to prioritize cooling of the motor 4 between cooling of the battery 3 and cooling of the motor 4, while mildly warming the battery 3. When Step S14 is performed, the control routine is terminated.

Moreover, in a case where the temperature of the battery cells 33 is higher than the first predetermined value (Step S11: No), the ECU 20 stops the first electric oil pump 6 and operates the second electric oil pump 7 (Step S15).

A case where a negative determination is made in Step S11, which is a condition for performing Step S15, is a case where the temperature of the battery cells 33 is higher than the first predetermined value. In this case, in a case of, for example, a third temperature situation (3) illustrated in FIG. 9, Step S15 is performed to cool the battery 3. In a configuration where the temperature of the battery cells 33 and the temperature of the motor 4 are used to control switching among warm-up, temperature retention, and cooling of the battery 3, in a case where the temperature of the battery cells 33 is higher than the first predetermined value, cooling of the battery 3 is prioritized regardless of the temperature of the motor 4. When Step S15 is performed, the control routine is terminated.

FIG. 10 is a diagram illustrating a flow of the oil for temperature retention of the battery 3. Note that, in FIG. 10, a thick line indicates a situation in which the oil is flowing in an oil passage. Moreover, the situation illustrated in FIG. 10 represents a case where Step S14 described above is performed.

As illustrated in FIG. 10, for temperature retention of the battery 3, both the first electric oil pump 6 and the second electric oil pump 7 operate and both a first check valve 8 and a second check valve 9 open; therefore, the oil flowing through a first oil passage 11 and the oil flowing through a second oil passage 12 converge at a junction 13. In this situation, the ECU 20 controls an amount of the oil discharged from the first electric oil pump 6 and an amount of the oil discharged from the second electric oil pump 7 so that a pressure at the junction 13 of the oil discharged from the first electric oil pump 6 and a pressure at the junction 13 of the oil discharged from the second electric oil pump 7 may become equal. For example, in a case where the amount of the oil discharged from the second electric oil pump 7 is fixed, the ECU 20 regulates the amount of the oil discharged from the first electric oil pump 6. In this case, the ECU 20 operates the first electric oil pump 6 so as to ensure balance with a pressure loss in the second oil passage 12 from a discharge opening of the second electric oil pump 7 to the junction 13. This makes both the first check valve 8 and the second check valve 9 open, and a volume of flow from the first electric oil pump 6 and a volume of flow from the second electric oil pump 7 can be added at the junction 13. That is, the oil warmed by the exhaust heat of the transaxle 2 and the oil air-cooled by the oil cooler 5 converge at the junction 13. The converged oil is supplied to the battery 3.

As described above, according to the second embodiment, effects similar to those of the first embodiment are obtained, and the temperature of the battery 3 can be stabilized at an optimum temperature by simultaneously operating the first electric oil pump 6 and the second electric oil pump 7.

Moreover, when both the first electric oil pump 6 and the second electric oil pump 7 are stopped for purpose of temperature retention of the battery 3, supply of lubricant to portions to be lubricated such as a reduction gear 21 and a differential mechanism 22 stops, and lubricity decreases. In contrast, in the second embodiment, both the first electric oil pump 6 and the second electric oil pump 7 are operated for temperature retention of the battery 3. This allows an enough amount of the oil to be supplied to the portions to be lubricated, while stabilizing the temperature of the battery 3. Therefore, a decrease in lubrication performance of the transaxle 2 can be suppressed. This allows for management of the temperature of the battery 3 and ensuring of lubricity of the transaxle 2 at the same time in a circulation circuit 10 that circulates common oil.

Note that in the second embodiment described above, a temperature range related to the temperature of the motor 4 can be set as the second predetermined value in Step S12. In other words, as with the temperature range Y for the temperature of the battery cells 33 described above, a predetermined temperature range can be can be set as the second predetermined value.

In the disclosure, cooling and warm-up of the battery can be easily switched by switching operation of the first electric oil pump and operation of the second electric oil pump according to the temperature of the battery. Moreover, control becomes simple because all that is required is to control operation of each electric oil pump, and control of, for example, a changeover valve (electromagnetic valve) is not required. Furthermore, a circulation circuit becomes simple because a necessity for installation of a changeover valve or the like is eliminated.

According to this disclosure, by simultaneously operating the first electric oil pump and the second electric oil pump, warm oil from the first electric oil pump and cold oil from the second electric oil pump can be added and supplied to the battery. This allows the temperature of the battery to be stabilized at an optimum temperature.

According to this disclosure, the oil that has not passed through the oil cooler and the oil that has passed through the oil cooler can be converged at the junction before being supplied to the battery and the transaxle. This allows for cooling of the electric motor while stabilizing a change in temperature of the battery.

According to this disclosure, in a case where the temperature of the electric motor is on a high temperature side and well below an upper limit, warm-up of the battery can be prioritized over cooling of the electric motor by operating only the first electric oil pump.

According to this disclosure, in a case where the temperature of the battery is on a high temperature side and barely below the upper limit, cooling of the battery can be prioritized by operating only the second electric oil pump.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A battery cooling system comprising:
a circulation circuit configured to circulate common oil to a transaxle, a battery, and an oil cooler, the oil for lubrication of the transaxle being used to cool the battery;
a first electric oil pump that is disposed in a first oil passage configured to supply the oil to the transaxle and the battery, not through the oil cooler, in the circulation circuit;
a second electric oil pump that is disposed in a second oil passage configured to supply the oil to the transaxle and the battery through the oil cooler, in the circulation circuit; and
a controller configured to control the first electric oil pump and the second electric oil pump,
wherein the controller is configured to
operate the first electric oil pump and stop the second electric oil pump when a temperature of the battery is equal to or lower than a first predetermined value, and
stop the first electric oil pump and operate the second electric oil pump when the temperature of the battery is higher than the first predetermined value.

2. The battery cooling system according to claim 1, further comprising:
an electric motor that is disposed inside a case housing the transaxle, wherein
the oil is used to cool the electric motor,
the controller is configured to operate the first electric oil pump and the second electric oil pump when the temperature of the battery is equal to or lower than the first predetermined value and a temperature of the electric motor is higher than a second predetermined value, and
the second predetermined value is a temperature equal to or higher than the first predetermined value.

3. The battery cooling system according to claim 2, wherein
in the circulation circuit, the first oil passage and the second oil passage are arranged to converge at a junction disposed upstream of an inflow opening of the battery, and
when operating the first electric oil pump and the second electric oil pump, the controller is configured to control an amount of the oil discharged from the first electric oil pump and an amount of the oil discharged from the second electric oil pump to make a pressure at the junction of the oil discharged from the first electric oil pump and a pressure at the junction of the oil discharged from the second electric oil pump equal.

4. The battery cooling system according to claim 2, wherein
the controller is configured to operate the first electric oil pump and stop the second electric oil pump when the temperature of the battery is equal to or lower than the first predetermined value and the temperature of the electric motor is equal to or lower than the second predetermined value.

5. The battery cooling system according to claim 3, wherein
the controller is configured to operate the first electric oil pump and stop the second electric oil pump when the temperature of the battery is equal to or lower than the first predetermined value and the temperature of the electric motor is equal to or lower than the second predetermined value.

6. The battery cooling system according to claim 2, wherein
the controller is configured to stop the first electric oil pump and operate the second electric oil pump when the temperature of the battery is equal to or higher than the first predetermined value, regardless of the temperature of the electric motor.

7. The battery cooling system according to claim 3, wherein
the controller is configured to stop the first electric oil pump and operate the second electric oil pump when the temperature of the battery is equal to or higher than the first predetermined value, regardless of the temperature of the electric motor.

8. The battery cooling system according to claim 4, wherein
the controller is configured to stop the first electric oil pump and operate the second electric oil pump when the temperature of the battery is equal to or higher than the first predetermined value, regardless of the temperature of the electric motor.

9. The battery cooling system according to claim 5, wherein
the controller is configured to stop the first electric oil pump and operate the second electric oil pump when the temperature of the battery is equal to or higher than the first predetermined value, regardless of the temperature of the electric motor.
